(19) United States
(12) Patent Application Publication
(10) Pub. No.: US 2016/0192233 A1
(43) Pub. Date: Jun. 30, 2016

(54) CONGESTION CONTROL FOR A MULTIMEDIA SESSION

(71) Applicant: TELEFONAKTIEBOLAGET L M ERICSSON (PUBL), Stockholm (SE)

(72) Inventors: Zaheduzzaman SARKER, Luleå (SE); Samita CHAKRABARTI, Sunnyvale, CA (US)

(73) Assignee: Telefonaktiebolaget L M Ericsson (publ), Stockholm (SE)

(21) Appl. No.: 14/897,564

(22) PCT Filed: Jan. 24, 2014
(86) PCT No.: PCT/SE2014/050089

§ 371 Date: Dec. 10, 2015

Related U.S. Application Data
(60) Provisional application No. 61/834,629, filed on Jun. 13, 2013.

(51) Int. Cl. H04W 28/02; H04W 24/08; H04L 29/06

(52) U.S. Cl. CPC H04W 28/0289; H04L 65/601; H04L 65/403; H04W 24/08

(57) ABSTRACT

Congestion control is achieved by assigning flow identifiers to media flows sharing source and destination addresses. Performance measurements between a sender and a receiver and/or routers are performed and used to detect a congestion state for a flow route in a transport network. A media flow, a media rate to adapt to combat the congestion state, is identified based on the assigned flow identifiers and mapping information defining a mapping between flow routes and flow identifiers.

### TECHNICAL FIELD

The present embodiments generally relate to congestion control, and in particular to such congestion control for multimedia sessions.

### BACKGROUND

A real-time communication session can consist of one or several independent or related media streams. It can be a point-to-point session where end-points are directly connected to each other with a transport network providing the connectivity or a point-to-multipoint session where two or more participants actively join a session. Real-time media applications, especially video applications, require high bit rate streams and low latency to provide acceptable user experience. This possesses great demands on the transport network.

Congestion is a state of the sustained network overload when the demand for the network resources exceeds current capacity of the link between any two network nodes. From media application point of view, congestion control is a mechanism that enables overcoming the congestion in the network by adapting media rate, such as bit rate, frame rate, resolution or any combination of them, transmitted into the network.

In a point-to-point session the media adaptation is usually done at the end-points. The procedure of detecting congestion and taking adaptation decision could be implemented in the sender of the media or the receiver of the media or the responsibly can be distributed over both the end-points. Irrespective of the implementation, the end-points usually look at different Quality of Service (QoS) parameters like packet loss information, delay in the media delivery and explicit congestion notifications from the network, for example, Explicit Congestion Notification (ECN), to detect the congestion.

The commonly used protocol to establish point-to-point session is Real-time Transport Protocol (RTP). For a RTP session, Real-time Transport Control Protocol (RTCP) reports and some extensions of RTCP feedback messages, such as Temporary Maximum Media Stream Bit Rate Request (TMMBR), is used by the adaptation algorithms as adaptation signaling between end-points. When the sender sends more than one stream to the receiver then the receiver will have to report impairment metrics on each flow individually or send rate requests for each flow. It is possible that the sender can aggregate different estimations reported for different flows and generate a total view of the available session bandwidth for all of the current media flows. This will help the sender to efficiently distribute the current available bandwidth among all the flows based on some criteria, for example media priority. This will allow the sender to maximize the user experience by providing more important information with high quality.

Now-a-days, adapting media streams to address congestion in the transport link between network nodes is becoming a common feature in the communication suits. This has become important since it allows continuation of the communication session in a congested network situation; otherwise the communication would have been dropped. However, in a multimedia communication session it is still difficult to detect a common congested bottleneck and adapt the affected streams in an efficient way. Thus, a main problem with current solutions is that they have no indication where the bottleneck resides and how many of flows an ongoing communication are sharing the same bottleneck.

Jesup and Mozilla, Congestion control requirements for real time media, Network Working Group, Internet-Draft, Mar. 4, 2012, discusses the unique requirements with regard to congestion control for interactive, point-to-point real time multimedia. The congestion control requirements for multimedia are different from the requirements for bulk transfer like File Transfer Protocol (FTP) and bursty transfers like Web pages. The document concludes that Transmission Control Protocol (TCP) congestion algorithms are not suitable for such multimedia traffic.

### SUMMARY

It is a general objective to provide an efficient congestion control for a multimedia session.

It is a particular objective to enable selection of a suitable media flow to adapt to combat a congestion state.

These and other objectives are met by embodiments disclosed herein.

An aspect of the embodiments relates to a method of congestion control for a multimedia session. The method comprises assigning a respective flow identifier to each media flow of multiple media flows having a same source address and a same destination address. The method also comprises performing two-way network performance measurements between a sender of the multiple media flows and at least one of a receiver of the multiple media flows and routers present in a transport network and configured to route the multiple media flows from the sender through the transport network to the receiver. The method further comprises detecting, based on at least a portion of the two-way network performance measurements, a congestion state for a flow route in the transport network affecting at least one media flow of the multiple media flows. The method additionally comprises identifying a media flow of the multiple media flows, a media rate of which is to be adapted to combat the congestion state for the flow route based on at least a portion of the flow identifiers and mapping information defining a mapping between flow routes through the transport network and flow identifiers for the multiple media flows.

Another aspect of the embodiments relates to a device for congestion control of a multimedia session. The device is operable to assign a respective flow identifier to each media flow of multiple media flows having a same source address and a same destination address. The device is also operable to perform two-way network performance measurements between a sender of the multiple media flows and at least one of a receiver of the multiple media flows and routers present in a transport network and configured to route the multiple media flows from the sender through the transport network to the receiver. The device is further operable to detect a congestion state in the transport network affecting at least one media flow of the multiple media flows in the transport network based on at least a portion of the two-way network performance measurements. The device is additionally operable to identify a media flow of the multiple media flows, a media rate of which is to be adapted to combat the congestion state, based on at least a portion of the flow identifiers and mapping information defining a mapping between flow routes through the transport network and flow identifiers for the multiple media flows.

A further aspect of the embodiment relates to a device for congestion control of a multimedia session. The device comprises an identifier assigning module for assigning a respective flow identifier to each media flow of multiple media flows having a same source address and a same destination address. The device also comprises a measuring module for performing two-way network performance measurements between a sender of the multiple media flows and at least one of a receiver of the multiple media flows and routers present in a transport network and configured to route the multiple media flows from the sender through the transport network to the receiver. The device further comprises a detecting module for detecting a congestion state in the transport network affecting at least one media flow of the multiple media flows in the transport network based on at least a portion of the two-way network performance measurements. The device additionally comprises an identifying module for identifying a media flow of the multiple media flows, a media rate of which is to be adapted to combat the congestion state, based on at least a portion of the flow identifiers and mapping information defining a mapping between flow routes through the transport networks and flow identifiers for the multiple media flows.

Yet another aspect of the embodiments relates to a user terminal comprising a device for congestion control according to above.

A further aspect of the embodiments, relates to a computer program comprising program code which when executed by a processor causes the processor to assign a respective flow identifier to each media flow of multiple media flows having a same source address and a same destination address. The program code also causes the processor to perform two-way network performance measurements between a sender of the multiple media flows and at least one of a receiver of the multiple media flows and routers present in a transport network and configured to route the multiple media flows from the sender through the transport network to the receiver. The program code further causes the processor to detect a congestion state in the transport network affecting at least one media flow of the multiple media flows in the transport network based on at least a portion of the two-way network performance measurements. The program code additionally causes the processor to identify a media flow of the multiple media flows, a media rate of which is to be adapted to combat the congestion state, based on at least a portion of the flow identifiers and mapping information defining a mapping between flow routes through the transport networks and flow identifiers for the multiple media flows.

A related aspect of the embodiments defines a computer program product comprising computer readable code mans and a computer program as defined above stored on the computer readable code means.

The present embodiments provide an efficient congestion control for multimedia sessions by not blindly adapting all media flows but rather make a deliberate decision on which media flow to adapt to combat a congestion state.

### BRIEF DESCRIPTION OF THE DRAWINGS

The embodiments, together with further objects and advantages thereof, may best be understood by making reference to the following description taken together with the accompanying drawings, in which:

FIG. 1 illustrates an example of a network node setup;

FIG. 2 illustrates an example network setup with TWAMP test sessions;

FIG. 3 illustrates another example network setup with TWAMP test sessions;

FIG. 4 illustrates a further example network setup with TWAMP test sessions;

FIG. 5 is a flow chart of a method for congestion control according to an embodiment;

FIG. 6 is a flow chart of an embodiment of the assigning step in FIG. 1;

FIG. 7 is a flow chart of an optional step of the method in FIG. 6;

FIG. 8 is a flow chart of optional steps of the method in FIG. 7;

FIG. 9 is a flow chart of an embodiment of the performing and detecting steps in FIG. 1;

FIG. 10 is a flow chart of an embodiment of the identifying step in FIG. 1;

FIG. 11 is a flow chart of another embodiment of the performing and detecting steps in FIG. 1;

FIG. 12 is a flow chart of another embodiment of the identifying step in FIG. 1;

FIG. 13 is a flow chart of an embodiment of the performing step in FIG. 11;

FIG. 14 is a flow chart of optional steps of the method in FIG. 11;

FIG. 15 is a flow chart for method 1;

FIG. 16 is a flow chart for method 2;

FIG. 17 is an illustration of a device for congestion control according to an embodiment;

FIG. 18 is an illustration of a device for congestion control according to another embodiment;

FIG. 19 is an illustration of a CCM according to an embodiment;

FIG. 20 is an illustration of a BDM according to an embodiment;

FIG. 21 is an illustration of a device for congestion control according to a further embodiment;

FIG. 22 is an illustration of a device for congestion control according to yet another embodiment;

FIG. 23 is an illustration of a user terminal according to an embodiment;

FIG. 24 is an illustration of a user terminal according to another embodiment; and

FIG. 25 is an illustration of a computer program and a computer program product according to an embodiment.

### DETAILED DESCRIPTION

Throughout the drawings, the same reference numbers are used for similar or corresponding elements.

The present embodiments generally relate to congestion control, and in particular such congestion control for multimedia sessions. Multimedia sessions, and in particular real-time multimedia sessions, have requirements that differentiate from other types of communication sessions, such as bulk transfer, e.g. FTP-based sessions, and bursty transfer, e.g. Web pages. The multimedia sessions are often characterized by requirements for low latency and delay, high bitrate and semi-reliable data delivery in order to achieve acceptable user experience. This further implies that prior art congestion control solutions adapted to other types of communication sessions, such as TCP-based congestion control algorithms, are generally not available or suitable for multimedia sessions, and in particular real-time multimedia sessions. In clear contrast, the TCP congestion control algorithms were developed for reliable bulk transfer of non-time-critical data.

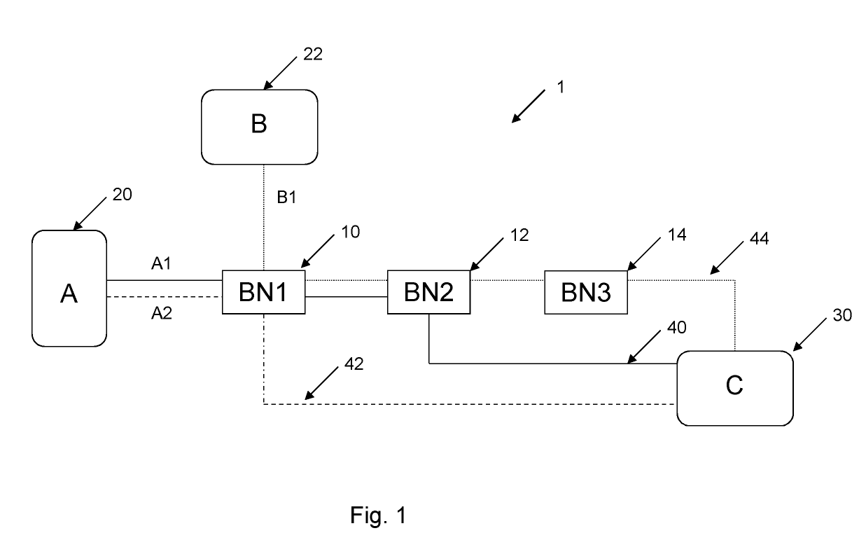

FIG. 1 illustrates an example of a network node setup. In a setup like FIG. 1, where A 20 is sending two different flows 40, 42 to C 30, congestion can happen in BN1 10, BN2 12 or BN3 14. With the existing prior art solutions, C 30 will monitor Explicit Congestion Notification-Congestion Encountered (ECN-CE) marked packets, delays, losses and try to detect congestion. If C 30 detects congestion in flow A1 40 then the congestion could happen either in BN1 10 or in BN2 12. Now, as A1 40 and A2 42 are coming from same application and A1 40 has higher priority than A2 42, the application's congestion controller of the prior art may decide to adapt A2 42 as it thinks they (A1 40 and A2 42) traverse the same media path. In this particular situation, adapting A2 42 will have no effect in mitigating congestion in BN2 12. The application can, however, adapt both A1 40 and A2 42. But adapting A2 42 will be unnecessary and inefficient. This is why knowing where congestion is happening becomes so important.

A main problem with current prior art solutions is that they have no indication where the bottleneck residues and how many flows of an ongoing communication are sharing the same bottleneck.

In another example, as shown in FIG. 1, both A 20 and B 22 are sending traffic to destination C 30. If bottleneck BN1 10 is congested then all the flows from A 20 and B 22 will experience that but if BN2 12 is congested then not all flows from A 20 will experience the congestion even though they are from same application or same host. A 20 may observe congestion in A1 40. Now if A 20 maintains a common controller for all the flows (A1 40, A2 42) then it may unnecessarily reduce flow A2 42 as flow A1 40 has higher priority. However that will not help improving the congestion but make the user experience worse. In this case detecting a common bottleneck or pinpointing the bottleneck and flows going through that problem node is important.

At least some of the disadvantages mentioned above is solved by the provided embodiments. The embodiments provide a way to discover shared bottleneck in the transport network to help adaptation algorithms to smartly handle media adaptation of an ongoing real-time communication session.

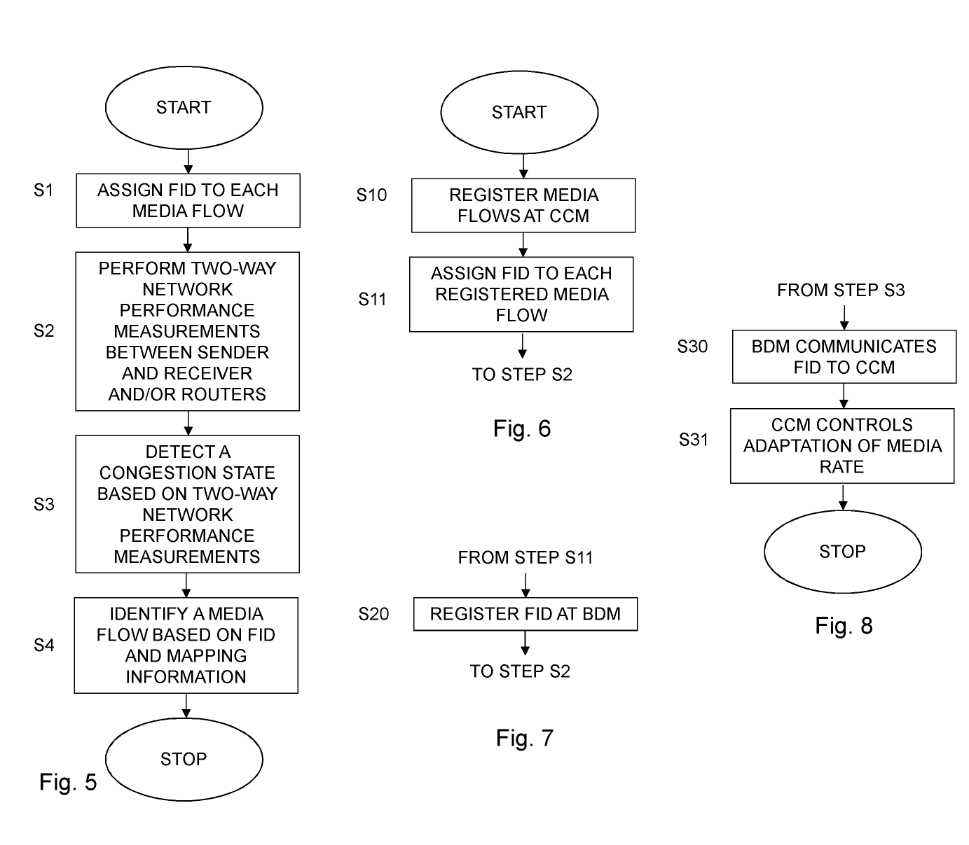

An aspect of the embodiments relates to a method of congestion control for a multimedia session. FIG. 5 is a chart of an embodiment of such a method. The method generally starts in step S1, where a respective flow identifier (FID) is assigned to each media flow of multiple media flows having a same source address and a same destination address. Step S2 comprises performing two-way network performance measurements between a sender of the multiple media flows and at least one of a receiver of the multiple media flows and routers present in a transport network and configured to route the multiple media flows from the sender through the transport network to the receiver. In step S3 a congestion state for a flow route affecting at least one media flow of the multiple media flows is detected in the transport network based on at least a portion of the two-way network performance measurements. Step S4 comprises identifying a media flow of the multiple media flows, a media rate of which is to be adapted to combat the congestion state for the flow route. This identification of the media flow in step S4 is performed based on at least a portion of the flow identifiers and mapping information defining a mapping between flow routes through the transport network and flow identifiers for the multiple media flows.

The embodiments thereby assign unique so-called flow identifiers to each media flow 40, 42 having a same source address and a same destination address. These addresses are preferably source Internet Protocol (IP) address and destination IP address. The source IP address identifies the sender 20 of the media flows 40, 42, i.e. A in FIG. 1, and the destination IP address identifies the receiver 30 of the media flows 40, 42, i.e. C in FIG. 1.

The flow identifiers assigned to the media flows 40, 42 are preferably dedicated for use during congestion monitoring and combatting any detected congestion state. Thus, the flow identifiers are preferably assigned to the respective media flows 40, 42 by an entity, preferably in the sender 20, that is configured or operable to perform congestion control on behalf of the sender 20.

In a particular embodiment, address information of a media flow is used together with information of traffic characteristics of the media as assigned flow identifier for a media flow. The address information preferably comprises the source and destination address of the media flow and more preferably the source IP address and the destination IP address of the media flow. This data is generally available from the IP headers of the data packets carrying the media data of the media flow. Thus, the address data can be read or retrieved from the IP headers of the data packets for the media flow.

Information of the traffic characteristics is preferably in the form of a Differentiated Services Code Point (DSCP) value assigned to the media flow. Differentiated services (DiffServ) is a computer networking architecture that specifies a simple, scalable and coarse-grained mechanism for classifying and managing network traffic and providing quality of service (QoS) on modern IP networks. DiffSery can, for example, be used to provide low-latency to critical network traffic such as voice or streaming media while providing simple best-effort service to non-critical services such as web traffic or file transfers. DiffSery uses the 6-bit Differentiated services Field (DS field) in the IP header for packet classification purposes. This DS field contains a 6-bit DSCP value. Hence, in theory, a network could have up to 2⁶=64 different traffic classes using different DSCPs values. More information of DSCP can be found in Nichols et al., Definition of the Differentiated Services Fiedl (DS Field) in the IPv4 and IPv6 Headers, Network Working Group, Request for Comments: 2474, December 1998.

Thus, in a particular embodiment the flow identifier for a media flow are determined based on the source IP address, destination IP address and DSCP value of that media flow.

For instance, the flow identifier of a media flow can comprise the source IP address, destination IP address and DSCP value of that media flow. The flow identifier may optionally also comprise additional data that can be used to identify the particular media flow. Such additional data could be a salt to create a unique flow identifier. A further alternative is to have a flow identifier that additionally comprises information of port numbers for the media port, such as source port and/or destination port. Hence, in an example the flow identifier comprises or is equal to the source IP address, destination IP address, source port, destination port, DSCP value and optionally a salt.

The flow identifiers are, in an embodiment, assigned to each outgoing media flow that could be adapted. Hence, a respective flow identifier is, in such an embodiment, assigned to each media flow even if the media flows may have different destination addresses.

The two-way network performance measurements in step S2 are performed between the sender 20 and the receiver 30 and/or between the sender 20 and the routers 10, 12 present in the transport network 1 for routing the media flows 40, 42 from the sender 20 to the receiver 30. The measurements could be any two-way measurements that reflect or at least provide an indication of network performance between the sender 20 and the receiver 30 and/or routers 10, 12. Non-limiting examples of such network performance characteristics that could be monitored and estimated during the measurements include latency, jitter, packet loss and/or delay variations.

The measurements are two-way measurements. This indicates that each measurement session involves two entities: an entity that sends data to another entity, which in turn returns data to the sending entity.

A non-limiting but preferred embodiment of such two-way network performance measurements is based on Two Way Active Measurement Protocol (TWAMP). Hence, a preferred embodiment of step S2 comprises performing TWAMP measurements between the sender 20 and at least one of the receiver 30 and the routers 10, 12.

TWAMP is a two-way active performance measurement protocol containing a sender and a reflector. The sender is responsible for initiating the test sessions and sending test packets to the reflector, which receives the packets, time stamps and put relevant information in the TWAMP test packets. Then, the reflector sends back the packets toward the sender. By doing this TWAMP is able to measure end-to-end latency, packet loss, delay-variation, etc. between two end-point IP-addresses and can help realizing the network overload at a certain point of time. It can run multiple test sessions between two IP end-points. In such a case, each test session can be identified by a set of parameters including source IP address, destination IP address, source port, destination port, and transport protocol, i.e. <ip-src, ip-dst, src-port, dst-port, protocol>. The test session can further be characterized by the same DSCP value as in the traffic. This will be further described herein.

In the media application scenario, TWAMP can be used to gauge the congestion in the network by creating multiple sessions to different media destinations and intermediary network nodes and also assigning the TWAMP packets with same IP traffic characteristics, such as DSCP.

Measuring the performance of the link and taking the data to do congestion control by identifying network bottleneck are the primary principles of this work.

More information about TWAMP can be found in Hedayat et al., A Two-Way Active Measurement Protocol (TWAMP), Network Working Group, Request for Comments: 5357, October 2008 (denoted RFC 5357 herein).

In such a case, the sender 20 preferably acts as TWAMP sender, also referred to as session-sender, with the receiver 30 as TWAMP reflector, also referred to as session-reflector, and/or the routers 10, 12 as TWAMP reflectors. The TWAMP sender then sends TWAMP test packets to the respective TWAMP reflectors. The TWAMP test packets are received and time stamped by the TWAMP reflectors. The TWAMP reflector preferably copy the packet sequence number into a corresponding reflected packet destined to the TWAMP sender. The TWAMP reflector sends a TWAMP test packet back to the TWAMP sender in response to the received packet. The TWAMP reflector also adds information about the actual sending time as its time stamp in the packet. This permits the determination of the elapsed time between the reception of the packet and its transmission.

The two-way network performance measurements, preferably TWAMP measurements, performed in step S2 could be performed periodically between the sender 20 and the receiver 30 and/or the routers 10, 12. Alternatively, they can be performed at scheduled time instances or upon selected triggering events, such as reception of a request for monitoring current network performance in the transport network 1.

The two-way network performance measurements, such as TWAMP measurements, performed in step S2 are then used in step S3 to detect a congestion state for a flow route in the transport network 1. In this detection all the TWAMP measurement results obtained from step S2 could be used or at least a portion thereof. The detection in step S3 is therefore preferably performed based on at least one network performance metric or parameter obtained or derived from the TWAMP measurements, such as two-way latency, packet loss and/or delay variation.

In the case of TWAMP measurements, information of the sent TWAMP test packets and information of the received time stamped TWAMP packets can be used in the sender 20 in order to derive the particular network performance metric or parameter. For instance, the estimate time between transmission of a TWAMP test packet and reception of the TWAMP test packet can be used in order to calculate a latency or delay parameter value. Correspondingly, information of the number of lost TWAMP test packets can be used in order to calculate a packet loss parameter value.

The flow identifiers, or at least a portion thereof, assigned in step S1 are then used in step S4 together with the mapping information in order to identify at least media flow to adapt in order to combat the congestion state. Hence, the flow route that is causing the congestion is detected based on the two-way network performance measurements and the detected flow route is mapped into at least one media flow using the mapping information and the flow identifiers. Hence, the mapping information translates the detected flow route into at least one flow identifier of respective media flows that travels along the detected flow route. The at least one flow identifier is then used in order to determine which media flow(s) that travel(s) along the detected flow route. Hence, it is among the determined media flow(s) that a suitable media flow, the media rate of which is to be adapted, is selected.

Adaptation of media rate can be performed according to various embodiments. For instance, the bit rate of the media flow could be adapted, such as reduced; the frame rate could be adapted, such as reduced; the resolution of the media data carried in the media stream can be adapted, such as reduced; or any combination of them.

In a particular embodiment, a congestion control module (CCM) is provided at the sender 20 and preferably also at the receiver 30. In such a case, the assignment of flow identifiers in step S1 could be performed according to the embodiment as shown in FIG. 6. Hence, the multiple media flows 40, 42 originating from an application in the sender is registered at the CCM in step S10. The CCM then assigns, in step S11, a respective flow identifier to each media flow in registered at the CCM in step S10. The method continues to step S2 of FIG. 5.

The sender 20 comprises an application, which is a general entity or function responsible for providing or generating the media flows 40, 42. The application could, for instance, be a media engine generating media or video data to be transmitted through the transport network to the receiver 30. Alternatively, the application could represent a video camera filming a scene to generate video data of the media flows 40, 42. Further examples include a media server having access to multiple video or media channels that can be distributed to the receiver 30 as media flows. Actually, any application that generates or otherwise provides, such as fetches from a memory, media data to form media flows 40, 42 could register media flows 40, 42 at the CCM in step S10. The CCM then assigns each registered media flow a unique flow identifier that is used in the congestion control method.

In the case of, flow identifiers representing at least source and destination IP address together with DSCP values, the CCM could retrieve this data from the IP headers of the data packets of the registered media flows. Alternatively, the application explicitly communicates this data to the CCM.

In an embodiment as shown in FIG. 7, the method continues from step S11 in FIG. 6 to step S20 of FIG. 20. This step S20 comprises the CCM registering the flow identifiers at a bottleneck detection module (BDM) using an application programming interface (API). The method then continues to step S2 of FIG. 5. This step S2 preferably comprises the BDM performing the two-way network performance measurements between the sender 20 and at least one of the receiver 30 and the routers 10, 12. The following step S3 preferably comprises the BDM detecting the congestion state for the flow route in the transport network 1 based on at least a portion of the two-way network performance measurements.

Thus, in a particular embodiment, the congestion control method involves not only the previously mentioned CCM but also a BDM. This BDM is preferably also provided in the sender 20 and optionally but preferably also at the receiver 30. Real-time multimedia sessions are usually bi-directional, i.e. full duplex. In such a case, a CCM and a BDM is preferably provided both in the sender 20 and in the receiver 30. However, for a particular session from the sender 20 to the receiver 30 it could be sufficient with a CCM and a BDM at the sender 20.

The CCM and the BDM are able to communicate with each other using an API. The API then defines how the CCM and BDM communicates with each other and share relevant information with each other. Thus, the CCM forwards information of the assigned flow identifiers to the BDM. The BDM is then the module that performs the two-way network performance measurements, preferably the TWAMP measurements, with the receiver 30 and/or the routers 10, 12, such as with a respective BDM in the receiver 30 and/or the routers 10, 12. The BDM preferably also detects the congestion state based on the two-way network performance measurements, preferably the TWAMP measurements.

FIG. 8 is a flow chart illustrating additional, optional steps of the method involving the BDM and CCM. The method continues from step S3 of FIG. 5. A next step S30 comprises the BDM communicating, to the CCM, a respective flow identifier of any media flow affected by the congestion state for the flow route. The respective flow identifier is preferably provided by the BDM based on the mapping information. The CCM then controls, in step S31, the adaptation of a media rate of the media flow identified based on the respective flow identifier.

Hence, once the BDM has detected a congestion state for a flow route it preferably uses the mapping information in order to determine which media flow or flows that are transported through the transport network along the congested flow route. The BDM thereby uses the mapping information in order to retrieve flow identifier of any affected media flow and uses the API to communicate the flow identifier or identifiers to the CCM. The CCM can then take actions in order to control the adaptation of the media rate of the media flow or flows to combat the congestion state.

A multimedia session can have multiple streams and they can follow different network paths between communication peers. It is expected that streams having same 5 tuples (protocol, src_address, dst_address, src_port, dst_port) are routed via same network path. However, there are reasons like load balancing, node failures etc. which can lead to assign different network path to flows even if they share same 5 tuples. Also, to have 5 tuples for all RTP streams it is required that applications use port multiplexing. That is not always the situation.

In an embodiment, a first media flow 40 of the multiple media flows 40, 42 is routed through a first flow route in the transport network 1 between the sender 20 and the receiver 30. Correspondingly, a second media flow 42 of the multiple media flows 40, 42 is routed through a second, different flow route in the transport network 1 between the sender and the receiver 30.

Thus, the first and second media flows 40, 42 preferably have same source address (src_address) and destination address (dst_adress) but are routed between different flow routes in the transport network 1. FIG. 1 schematically illustrates an example where the flow route of the first media flow 40 involves router BN1 10 and router BN2 12 prior to reaching the sender 30. The second media flow 42 has another flow route involving the router BN1 10 but not router BN2 12.

In a particular embodiment, the first and second media flows 40, 42 have the same source and destination IP address but different DSCP values. The first and second media flows 40, 42 typically also have different ports, i.e. different combinations of source and destination ports.

Thus, the present embodiments provide a way of detecting shared bottleneck and give a way to the applications to do proper congestion control by using, in an embodiment, the CCM and the BDM and by assigning a unique identifier (FID) for each flow, by e.g. doing the following:
Application starts a call with multiple media flows which has a Congestion Control Module (CCM).
All flows have a unique identifier, FID.
A Bottleneck Detection Module (BDM) continuously monitors network performance and detects Bottleneck Node (BN) whenever there is congestion.
The BDM eventually identifies a BN which is shared by multiple flows from the application and reports to CCM.
CCM takes proper measure to select flows sharing same BN and adapts their rate.

In an embodiment, the Congestion Control Module (CCM) is responsible for adapting the flows 40, 42 between sender 20 and receiver 30. The CCM communicates with the BDM via a set of APIs to get indication on which flow to adapt and then communicate with the media entity, i.e. encoder, to enforce the adaptation on a particular flow. Whenever the application instantiate a media flow 40, 42 between a source and a destination, for example A 20 and C 30 in FIG. 1, the CCM assigns a unique flow id (FID) to the flow 40, 42 and uses that FID to communicate with the BDM. In an embodiment, it is therefore assumed that the application or UE (User Equipment) has proper APIs in place to communicate the source IP, destination IP and assigned DSCP values for a particular media session and media flow 40, 42.

A BDM is preferably a TWAMP-based controller or sender which resides at the origin of the application. The BDM could be integrated with the host of the application or can be in implemented inside the application or even can be placed at the transport network 1. In all cases there will be APIs so that the CMM and the BDM can communicate with each other.

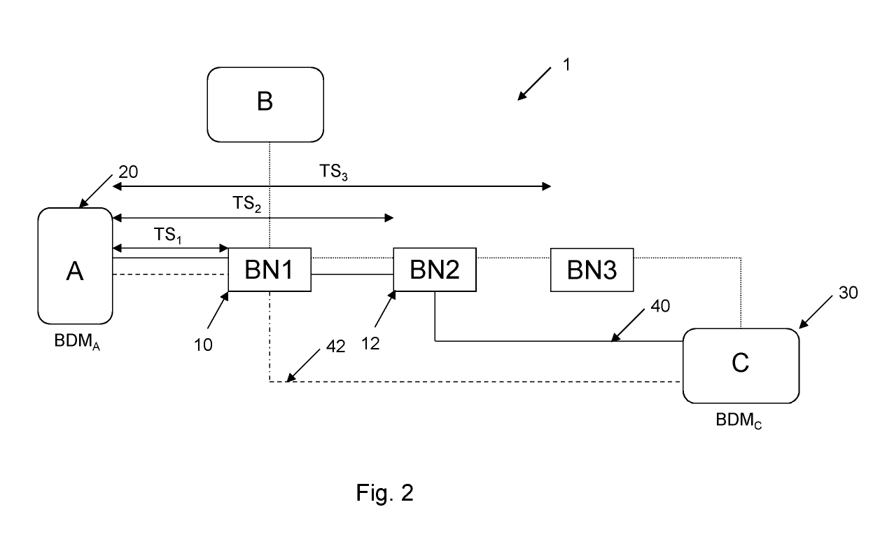

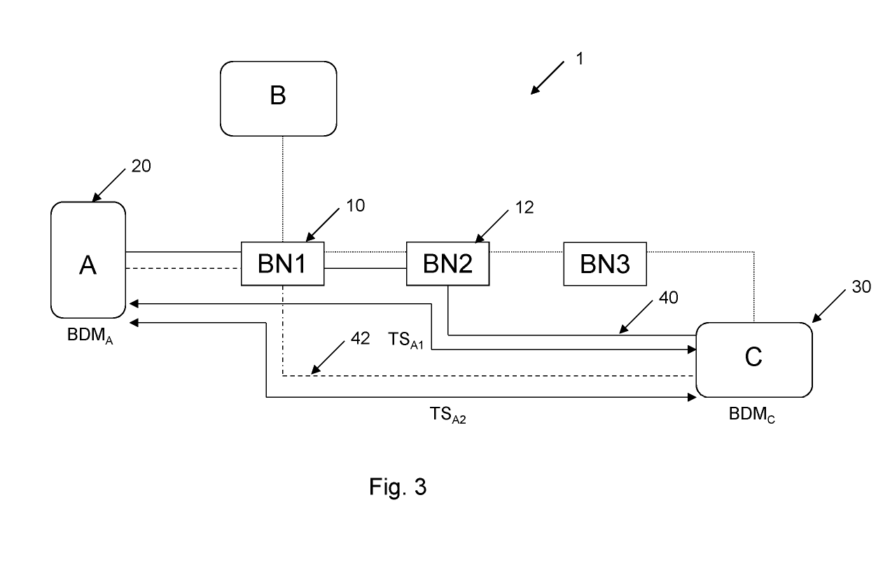

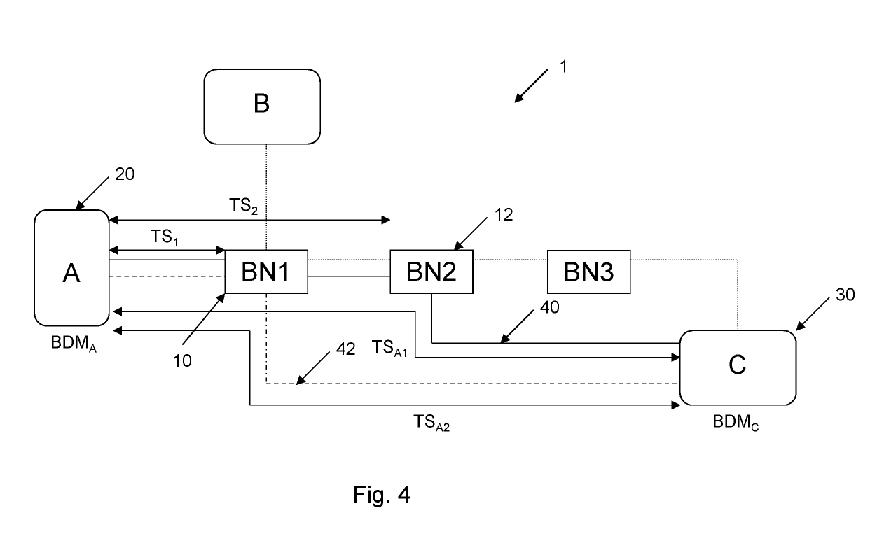

The BDM assumes, in a particular embodiment, that all the Bottleneck (BN) routers 10, 12, 14 implement TWAMP light reflectors or RFC 5357 standard reflectors. The BDM preferably creates TWAMP sessions with all the routers 10, 12, 14 that are involved in the communication path between sender 20 of the media and receiver 30 of the media, see FIG. 2, and preferably periodically does two-way delay, jitter, packet-loss measurement between the host of the BDM and the router 10, 12, 14 in the communication path. The BDM preferably includes a flow determination function that uses same source and destination TWAMP IP-addresses as the respective flows 40, 42 and uses same DSCP values. In our example here, the BDM at A 20, BDMA will maintain TWAMP sessions with BN1 10, BN2 12, BN3 14. Assume that the respective measurement results are M₁, M₂, M₃ and also assume the respective test session are TS₁, TS₂, TS₃, see FIG. 2. BDMA preferably also or alternative maintains test session TS_{A}1 and TS_{A}2 towards the BDM at C 30, BDMc, for flow A1 40 and flow A2 42, see FIGS. 3 and 4. Assume the respective measurements are M_{A}1 and M_{A}2. In this case, the flow determination function is preferably =F (A, C, DSCP). Here is it assumed that same routing/forwarding policies are applied on session TS_{A}1 and TS_{A}2 as flow A1 40 and flow A2 42 so that test sessions follow the same routing path as the media flows 40, 42. This can be done via DSCP values and associating DSCP value with the FID.

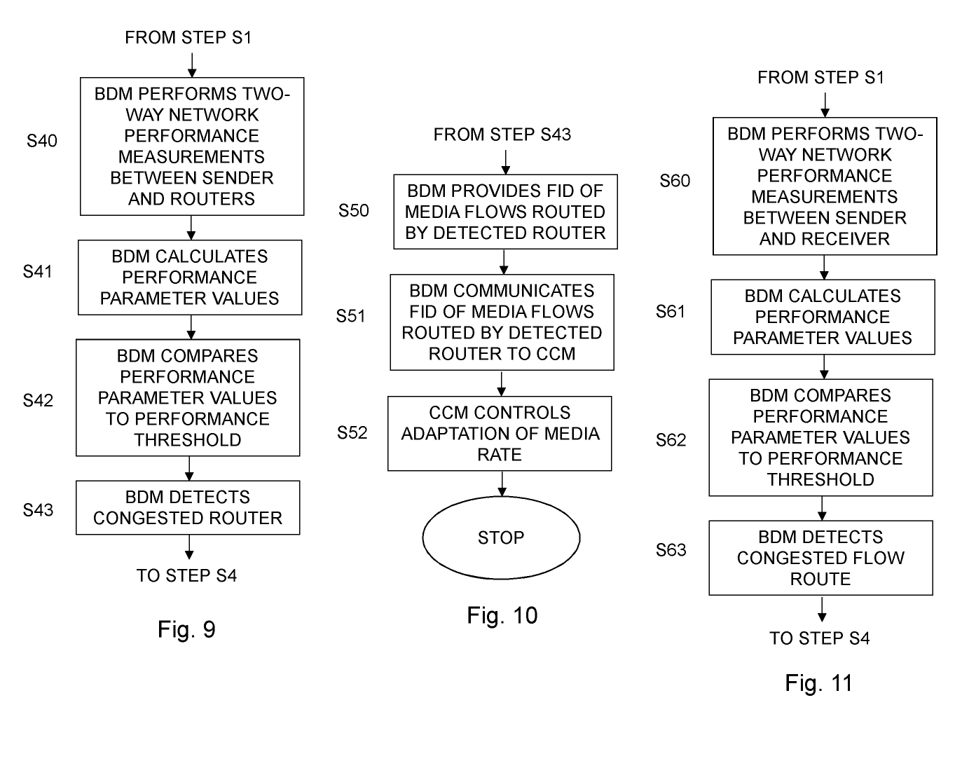

In an embodiment as further shown in FIG. 9, the method continues from step S1 in FIG. 5, or from step S11 in FIG. 6 or step S20 in FIG. 7. In a next step S40, the BDM performs two-way network performance measurements between the sender 20 and each router 10, 12 of the multiple routers 10, 12 present in the transport network 1 and configured to route the multiple media flows 40, 42. In a next step S41, the BDM calculates, based on the two-way network performance measurements, a respective parameter value for each transport link over which the multiple media flows 40, 42 are transported in the transport network 1. The BDM then compares, in step S42, the respective performance parameter values to a performance threshold. In a next step S43, the BDM detects, based on this comparison, a router 12 that is in the congestion state of the routers 10, 12 present in the transport network 1 and configured to route the multiple media flows 40, 42. The method then continues to step S4 of FIG. 5, where the media flow, the media rate of which is to be adapted to combat the congestion state, is identified based on information of the detected router 12, the mapping information and at least a portion of the flow identifiers.

In this particular embodiment, the BDM preferably is involved in TWAMP test sessions (TS₁, TS₂) with at least each router 10, 12 of the transport network 1 that is involved in forwarding the media flows 40, 42 from the sender 20 to the receiver 30. The respective TWAMP test session and measurements result in at least one respective performance parameter value (M₁, M₂). This performance parameter value could, for instance, represent latency, delay, jitter or packet loss. The performance parameter value could represent a single value obtained in the respective TWAMP test session, such as a most recent determined value of the particular performance characteristic (latency, delay, jitter or packet loss). Alternatively, the performance value could be calculated in step S41 as an average, median or variation of values obtained from multiple TWAMP test occasions.

The values obtained from the TWAMP measurements and test sessions TS₁, TS₂ typically represent the performance parameter for the transport link between the sender 20 and each respective router 10, 12. Hence, in order to obtain performance parameter values for each transport link, such as between sender 20 and first router 10 and between first router 10 and second router 12, the BDM preferably uses at least some of the values obtained from the TWAMP measurements performed in step S40. For instance, the performance parameter value M₁ for the link between the sender 20 and the first router 10 is typically obtained directly from the TWAMP measurements performed for the TWAMP test session TS₁. The performance parameter value for the link between the first router 10 and the second router 12 could, however, be calculated based on the performance parameter value M₁ and the performance parameter value M₂ for the link between the sender 20 and the second router 12 and obtained from the TWAMP measurements performed for the TWAMP test session TS₂. For instance, the performance parameter value for this router-to-router link could be calculated as a difference between M₂ and M₁ (M₂−M₁).

Each calculated performance parameter value (M₁, M₂−M₁) is then preferably compared to the performance threshold in step S42. If the performance parameter value represents a worse network performance than what is represented by the performance threshold then there is a significant risk for congestion. For instance, if the performance parameter represents delay then there is no congestion if the respective performance parameter value is below the performance threshold. However, if any of the performance parameter values exceeds, in this particular embodiment, the threshold value the BDM detects a congested router.

For instance, assume that M₁ is below the threshold value but (M₂−M₁) is not. The BDM can then conclude that the first router 10 is working correctly but detect that the second router 12 is in a congestion state.

The particular media flow to adapt can then be identified based on information of this detected router 12, which can be used in order to identify which media flows 40 that go through this router 12 using the mapping information. In an embodiment, this is possible since the TWAMP measurements involving the detected router 12 and the media flows 40 routed through this router 12 use a same DSCP value as previously described herein. This means that by detecting the router 12 the BDM is able to provide the relevant DSCP value that was assigned to the TWAMP test session TS₂ performed by the BDM between the sender 20 and the router 12. The DSCP value can then provide the flow identifier of any media flow 40 routed by the detected router 12 since, in an embodiment, the flow identifier preferably represents the source and destination (IP) address of the media flow together with the DSCP value for the media flow 40. Thus, the BDM is able to provide a list of flow identifiers of the media flows 40 routed by the congested router 12. In this embodiment, the mapping information therefore preferably lists, for each router 10, 12, flow identifiers of the media flows routed by the particular router 10, 12 from the sender 20 towards the receiver 30 in the transport network 1.

FIG. 10 is a flow chart illustrating additional, optional step of the method as shown in FIG. 9 according to an embodiment. The method continues from step S43 of FIG. 9. In a next step S50 the BDM provides, based on the mapping information, a respective flow identifier of any media flow 40 routed through the detected router 12. The BDM then communicates, in step S51, the respective flow identifier to the CCM using the API. In step S52 the CCM controls adaptation of a media rate of the media flow 40 identified based on the respective flow identifier.

Thus, in this embodiment, when a congestion state is detected and a shared bottleneck is detected, i.e. router 12, the BDM sends the flow identifiers of the media flows 42 sharing this bottleneck to the CCM. The CCM then groups them together and does rate adaptation in order to combat the congestion state.

The provision of flow identifiers as performed by the BDM in step S50 is preferably performed based on the DSCP values of the media flows and the DSCP values of the two-way network performance measurements (TWAMP measurements) conducted by the BDM for the sender 20 and the routers 10, 12.

Here below a particular implementation example will be provided denoted Shared Bottleneck Detection Function (Method 1).

Method 1 uses measurements towards TWAMP to determine the bottleneck points in the communication path and based on their results it chooses one of the flows to do the rate adaptation.

In method 1, the BDM assumes
The deployment policy allows a threshold measurement, for instance delay, jitter, loss, between two consecutive nodes due to maximum allowable congestion.
A 20 has knowledge about the intermediate bottleneck nodes 10, 12 and the flows 40, 42 passing through them.
Policy is that if measured two-way delay exceeds threshold TM, then A 20 starts congestion control for the flows 40, 42 that traverse via the particular nodes 10, 12.

In the example scenario, see FIG. 2:

M₂=Measurement from A (TWAMP sender) 20 to BN2 (reflector) 12, for instance one-way-delay.
M₁=Measurement from A (TWAMP sender) 20 to BN1 (reflector) 10, for instance one-way-delay.

Hence, (M₂−M₁)=indicates the delay between BN1 10 and BN2 12.

Now, if M₁<TM and (M₂−M₁)>TM, then we can assume that BN1 10 is fine and there is problem in the path between BN1 10 and BN2 12 or in BN2 12 itself. This way we can isolate the bottleneck in the network 1 and select proper flows 42 to be adapted. Hence, BDMA indicates to the CCM to start adaption on flows 42 that pass through BN2 12. This means that A 20 only has to adapt flow A2 42 and does not need to adapt A1 40 at all.

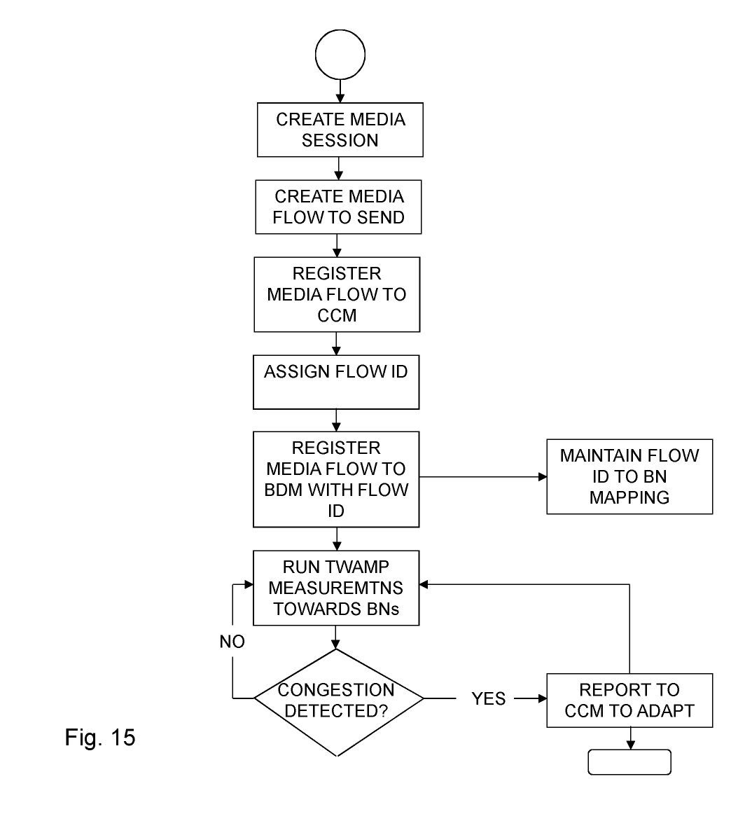

FIG. 15 is a flow chart summarizing the operation steps of this particular implementation example. A media session is created involving the sender 20 and the receiver 30. Media flows 40, 42 to send during the media session towards the receiver 30 are created. These media flows 40, 42 are registered to a CCM, such as by providing information of the source and destination IP address and DSCP values of the created media flows 40, 42. Flow identifiers are assigned to the registered media flows 40, 42 by the CCM. The CCM also registers the media flows 40, 42 to the BDM by providing the flow identifiers of the media flows 40, 42. The BDM maintains a mapping between flow identifiers and potential bottleneck nodes (BN), i.e. routers 10, 12 in the transport network 1. The BDM runs TWAMP measurements towards the BNs 10, 12. Such TWAMP measurements are preferably performed periodically or at scheduled time instances. The BDM uses the TWAMP measurements in order to detect any congestion. If the BDM detects a congestion state it reports information of the congested BN 12 to the CCM to enable the CCM to identify at least one media flow 42 routed by the congested BN 12 and adapt the media rate of the at least one media flow 42.

In another embodiment as further shown in FIG. 11, the method continues from step S1 in FIG. 5, or from step S11 in FIG. 6 or step S20 in FIG. 7. In a next step S60, the BDM performs two-way network performance measurements between the sender 20 and the receiver 30 for each media flow of the multiple media flows having a respective DSCP value. In a next step S61, the BDM calculates, based on the two-way network performance measurements, a respective performance parameter value for each media flow of the multiple media flows. The BDM then compares the respective performance parameter values to a performance threshold in step S62. A next step S63 comprises the BDM detecting, based on the comparison performed in step S62, a flow route that is in the congestion state. The method then continues to step S4 of FIG. 5, where the media flow is identified based on information of the detected flow route, at least a portion of the flow identifiers and the mapping information.

In this particular embodiment, the BDM preferably is involved in TWAMP test sessions (TS_{A}1, TS_{A}2) with receiver 30 for each media flow 40, 42 from the sender 20 to the receiver 30, see FIG. 3. The respective TWAMP test session and measurement result in at least one respective performance parameter value (M_{A}1, M_{A}2). This performance parameter value could, for instance, represent latency, delay, jitter or packet loss. The performance parameter value could represent a single value obtained in the respective TWAMP test session, such as a most recent determined value of the particular performance characteristic (latency, delay, jitter or packet loss). Alternatively, the performance value could be calculated in step S61 as an average, median or variation of values obtained from multiple TWAMP test occasions.

This step S61 is basically performed as described in the foregoing in connection with step S41 of FIG. 9. The comparison as performed in step S62 between the calculated performance parameter values and the threshold values are preferably performed basically as discussed in the foregoing in connection with step S42 of FIG. 9.

In a particular embodiment, the source and destination IP address together with DSCP value can be used as flow identifiers for the media flows 40, 42. In such a case, the TWAMP measurement packets transmitted between the sender 20 and the receiver 30 in step S60 preferably also use the same flow identifier, i.e. source and destination IP address together with DSCP value, so that both media packets of each media flow 40, 42 and the respective TWAMP measurement packets are routed in the same flow route in the transport network 1. In such a case, the BDM preferably sends the flow identifier of any media flow affected by the congestion state for the flow route detected in step S63 to the CCM. The CCM can then use this flow identifier in order to determine which media flow(s) to adapt in order to combat the congestion state.

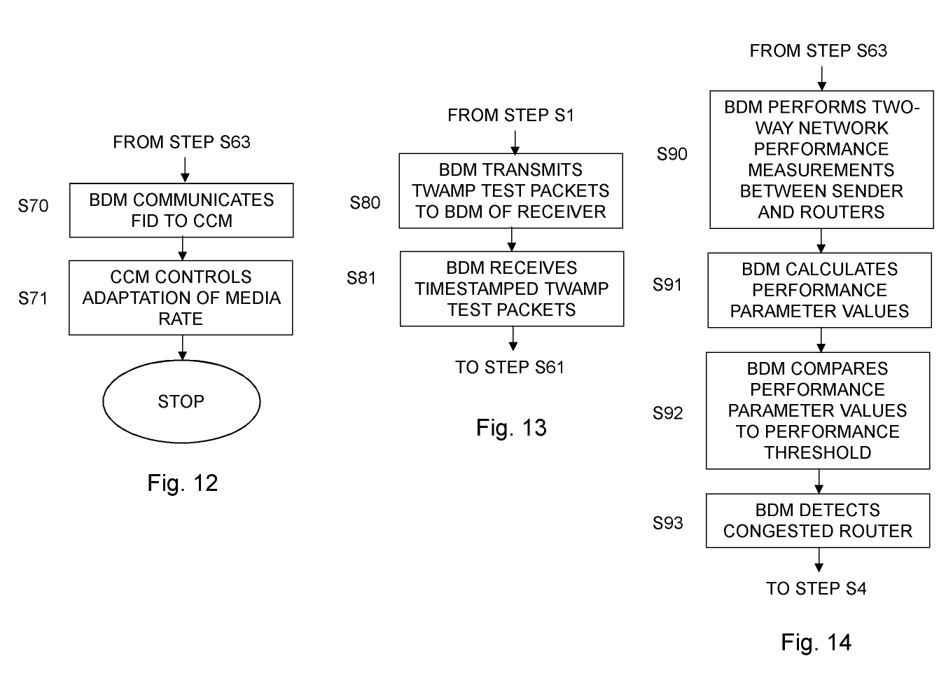

FIG. 12 is a flow chart illustrating additional, optional step of the method as shown in FIG. 11 according to an embodiment. The method continues from step S63 of FIG. 11. In a next step S70 the BDM communicates, to the CCM, a respective flow identifier of any media flow affected by the congestion state for the flow route. The respective flow identifier is provided by the BDM based on the mapping information. The CCM then controls, in step S71, adaptation of a media rate of the media flow identified based on the respective flow identifier.

Thus, the BDM communicates the flow identifier of the media flow routed along the flow route that is detected to be in a congestion state in step S63 of FIG. 11 to the CCM to enable the CCM to identify the relevant media flow and take actions, such as signaling to the application or the encoder, to change the media rate of this particular flow, such as reduce bit rate, reduce frame rate or reduce resolution of the video data of the media flow.

FIG. 13 is flow chart illustrating an embodiment of step S60 in FIG. 11. The method continues from step S1 in FIG. 5, or from step S11 in FIG. 6 or step S20 in FIG. 7. In a next step S80, the BDM transmits, for each media flow 40, 42 of the multiple media flows 40, 42, TWAMP test packets having a same source address, a same destination address and a same DSCP value as the media flow 40, 42 to a BDM of the receiver 30. The BDM then receives, in step S81 and from the BDM of the receiver 30, TWAMP test packets time stamped by the BDM of the receiver 30.

The BDM can then calculate, in step S61 of FIG. 11, the respective performance parameter value for the media flows 40, 42 based on the received TWAMP test packets and preferably also based on the transmitted TWAMP test packets.

Here below a particular implementation example will be provided denoted Shared Bottleneck Detection Function by flow path (Method 2).

In this method, the TWAMP measurements indicate the performance of the end to end flow path.

In method 2, the BDM assumes:
Media endpoints have TWAMP reflector functionalities and multiple flows 40, 42 are flowing between the fixed measurement endpoints.
The deployment policy allows a threshold measurement between source 20 and destination 30 due to maximum allowable congestion.
BDM module has knowledge about flow and a policy of action upon a flow if it faces maximum allowable congestion corresponding to delay value.
The CCM has a map or view of each flow-path such that a flow route can be determined by a flow-id, for example the DSCP value in the IP-header. Thus, flow A1 40 and A2 42 both have same IP source and destination but different DSCP values. BN1 10 is pre-provisioned to route flow A2 42 and pass flow A1 40 to BN2 12. We simulate this traffic behavior to TWAMP test sessions (session TS_{A}1 and TS_{A}2) which has the same IP source and destination and DSCP values respectively.
Session TS_{A}1 and TS_{A}2 provides measure M_{A}1 and M_{A}2 respectively.
If TS_{A}2 exceeds the threshold value, then flow A2 42 is adapted and vice-versa.
Note that in this method, it is preferred if each flow-id determines the path of flows 40, 42 between the source 20 and destination 30 and make TWAMP packet preferably follow the same flow-id based path. In an embodiment, DSCP-based flow-id is used, but it could be also traffic steering based configuration as well.
No intermediate node measurement is taken as in method 1. However, method 2 can be combined with method 1 to be accurate in determining the actually BN in the path.

In the example, if M_{A}1 or M_{A}2 exceeds the threshold value, then the BDMA detects congestion for the respective flow 40, 42 and indicates the CCM to adapt the correct flow. If flow A1 40 and flow A2 42 is following same route then congestion will be visible on both M_{A}1 and M_{A}2 as they will follow the same flow path and shared resources and the CCM will have to adapt both of the media flows 40, 42.

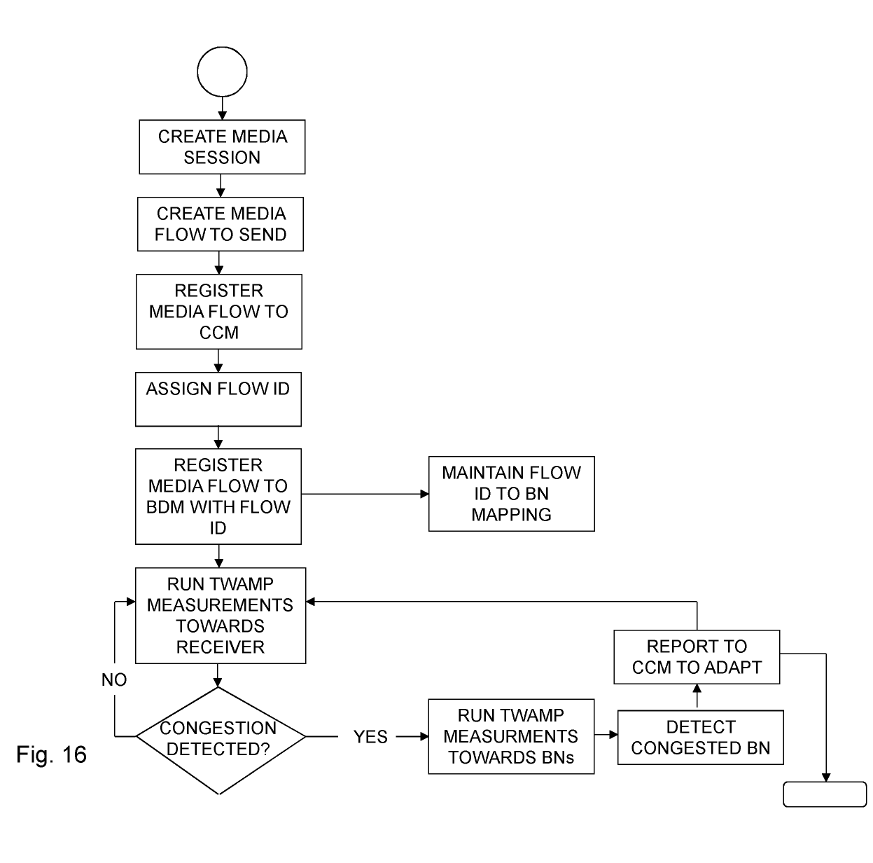

FIG. 16 is a flow chart summarizing the operation steps of this particular implementation example. A media session is created involving the sender 20 and the receiver 30. Media flows 40, 42 to send during the media session towards the receiver 30 are created. These media flows 40, 42 are registered to a CCM, such as by providing information of the source and destination IP address and DSCP values of the created media flows 40, 42. Flow identifiers are assigned to the registered media flows 40, 42 by the CCM. The CCM also registers the media flows 40, 42 to the BDM by providing the flow identifiers of the media flows 40, 42. The BDM maintains a mapping between flow identifiers and potential bottleneck nodes (BN), i.e. routers 10, 12 in the transport network 1. The BDM runs TWAMP measurements towards the receiver 20 for each media flow 40, 42. Such TWAMP measurements are preferably performed periodically or at scheduled time instances. The BDM uses the TWAMP measurements in order to detect any congestion. If the BDM detects a congestion state it reports information of the congested BN 12 to the CCM to enable the CCM to identify the media flow 42 that is regarded to be congested and adapt the media rate of the media flow 42.

FIG. 16 further illustrates additional operations that may be used in connection with method 2. Such an embodiment is basically a combination of method 2 and method 1. Hence, once a congested flow route has been detected, the BDM preferably runs TWAMP measurements towards the bottleneck nodes, i.e. routers, present in the transport network and configured to route media flows along the congested flow route. These TWAMP measurements are then used as discussed in FIG. 15 in order to detect the bottleneck node or nodes that is congested. The BDM can then report to the CCM information of the detected router and the congested media flow.

FIG. 14 is a flow chart illustrating additional, optional step of the method shown in FIG. 11 according to an embodiment. The method continues from step S63 of FIG. 11, in which the congested flow route was detected. The BDM performs two-way network performance measurements in step S90 between the sender 20 and each router 10, 12 of the routers 10, 12 present in the transport network 1 and configured to route media flows 40 through or along the detected flow route. The BDM then calculates, in step S91 and based on the two-way performance measurements, a respective performance parameter value for each transport link for the detected flow route in the transport network 1. A following step S92 comprises the BDM comparing the respective performance parameter values to performance threshold and then the BDM detects, in step S93 and based on the comparison, a router 12 of the routers 10, 12 present in the transport network 1 and configured to route media flows 40 through the detected flow route. The method then continues to step S4 of FIG. 5, where the media flow, the media rate of which that is to be adapted in order to combat the congestion state, is detected based on information of the detected router 12, at least a portion of the flow identifiers and the mapping information.

FIG. 4 illustrates this situation in which TWAMP measurements are performed not only between the sender 20 and the receiver 30, i.e. TS_{A}1, TS_{A}2, but also between the sender 20 and the routers 10, 12 involved in routing the detected media flow, i.e. TS₁, Ts₂.

In an embodiment, the BDMA has knowledge of the media flows 40, 42 and their flow routes. The BDMA preferably uses TWAMP measurements between itself and routers 10, 12, i.e. potential bottleneck points, TS₁, TS₂, and between itself and BDMc in the receiver 30, TS_{A}1, TS_{A}2. The sender 20 preferably keeps a database that maps the flow routes and routers 10, 12 and application policies on that flow route. The sender 20 preferably also keeps a performance measurement table based on the TWAMP measurements involving the routers 10, 12 and the BDMc. In an embodiment, DSCP values may be used as flow identifiers, preferably together with IP source and destination addresses, and identifiers of flow types, such as voice, video, etc. The DSCP values used for the respective media flows 40, 42 are copied into TWAMP test packets in order to direct the TWAMP test packets along the same respective flow routes as the media flows 40, 42.

An example of a database or table in the sender 20 could be as defined below:

| | |
|---|---|
| <A, BN1> | FID1, FID2, FID3, FID4, FID5, FID6, FID7, |
| | FID8 APP1 |
| <A, BN2> | FID4, FID5 APP2 |
| <A, BN3> | FID6, FID7, FID8 |
| <A, BN1, C> | FID1, FID2, FID3 |
| <A, BN2, C> | FID4, FID5 |
| <A, BN3, C> | FID6, FID7, FID8 |

An example of a performance measurement table in the sender 20 could be as defined below:

<A, BN1> delay=30 ms, jitter=5 ms/s
<A, BN2> delay=50 ms, jitter=1 ms/s
<A, BN3> delay=25 ms, jitter=5 ms/s
<A, BN1, C> delay=35 ms, jitter=2 ms/s
<A, BN2, C> delay=52 ms, jitter=5 ms/s
<A, BN3, C> delay=30 ms, jitter=2 ms/s

An implementation and deployment example of these tables can have many variations depending on the configuration, implementation and policies. However, based on the information provided in these tables, the sender 20 can intelligently make decision to adapt of the media flows passing BN2, i.e. media flows identified by flow identifiers FID4 and/or FID5.

The performance threshold discussed in the foregoing and compared to the calculated performance parameters values could be a single performance threshold. Alternatively, different performance thresholds can be used for different transport links or different flow routes.

Hence, embodiments of the present technology provide a way to discover shared bottleneck in the transport network to help adaption algorithms to smartly handle media adaption of an ongoing real-time communication session. Thus, the application does not need to blindly adapt all the media flows. Instead, it can make an efficient and easy decision on which flow to adapt.

In a particular embodiment, the application can enforce media priority as intended as it has specific knowledge about a particular flow.

In a fixed setup scenario, such as video conference call between different enterprise sites, the BDM can be active all the time in the application and help the application select a suitable start up rate for the current video conference.

Hence, this solution adds a new dimension to the end to end adaptation and completely different from the way it is done today.

Another aspect of the embodiments relates to a device for congestion control of a multimedia session. The device is operable to assign a respective flow identifier to each media flow of multiple media flows having a same source address and a same destination address. The device is also operable to perform two-way network performance measurements between a sender of the multiple media flows and at least one of a receiver of the multiple media flows and routers present in a transport network and configured to route the multiple media flows from the sender through the transport network to the receiver. The device is further operable to detect a congestion state in the transport network affecting at least one media flow of the multiple media flows in the transport network based on at least a portion of the two-way network performance measurements. The device is additionally operable to identify a media flow of the multiple media flows, a media rate of which is to be adapted to combat the congestion state, based on at least a portion of the flow identifiers and mapping information defining a mapping between flow routes through the transport network and flow identifiers for the multiple media flows.

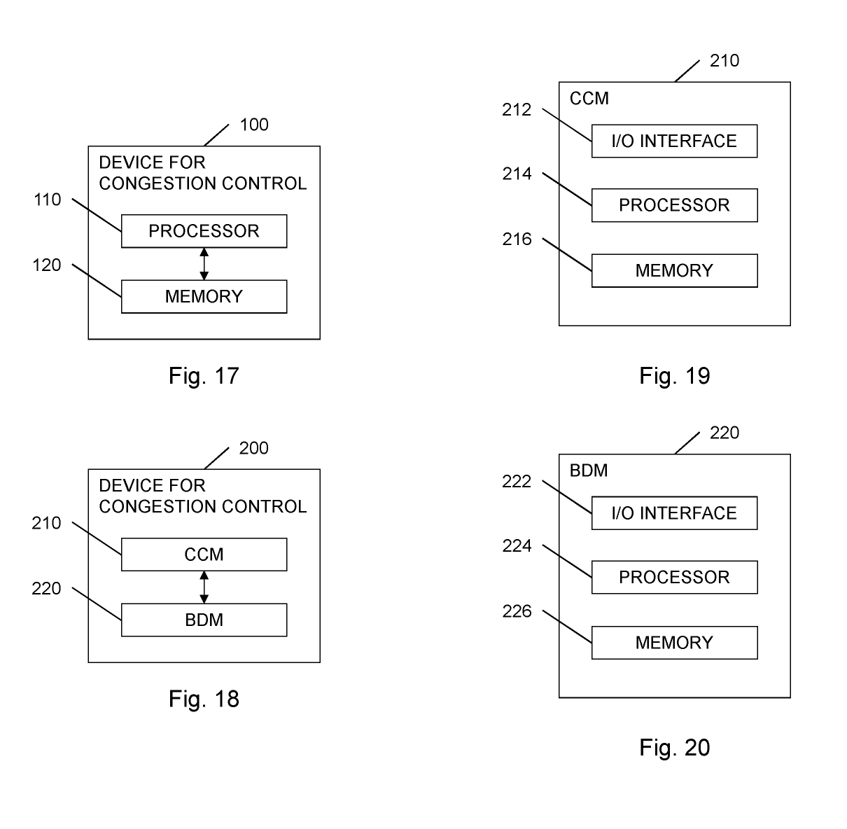

The device for congestion control 100 may, in an embodiment, be implemented as comprising a processor 110 and a memory 120, see FIG. 17. In such a case, the processor 110 is operable to assign the respective flow identifier to each media flow of the multiple media flows and perform the two-way network performance measurements between the sender and at least one of the receiver and the routers. The processor 110 is preferably also operable to detect the congestion state in the transport network based on at least a portion of the two-way network performance measurements. The processor 110 is further preferably operable to identify the media flow of the multiple media flows based on at least a portion of the flow identifiers and the mapping information.

The processor 110 and the memory 120 of the device 100 are preferably are interconnected to each other to enable normal software execution. In FIG. 17, the device 100 has been illustrated as comprising a processor 110 and a memory 120. This should, however, be interpreted as also encompassing embodiments in which the processor 110 is in the form of a processing circuitry comprising multiple processing units and/or the memory 120 is in the form of a memory circuitry comprising multiple memory units. In the latter case, a distributed implementation is possible with the processing units and/or memory units physically separated from each other but preferably able to communicate with each other using suitable means, such as data bus, wired connections or wireless connections.

In an embodiment, the processor 110 is preferably operable to perform TWAMP measurements between the sender and at least one of the receiver and the routers.

The processor 110 is, in an embodiment, preferably operable to register the multiple media flows originating from an application in the sender. The processor 110 is preferably also operable to assign a respective flow identifier to each registered media flow.

In an embodiment, the processor 110 is operable to perform two-way network performance measurements between the sender and each router of the routers present in the transport network and configured to route the multiple media flows. The processor 110 is preferably also operable to calculate, based on the two-way network performance measurements, a respective performance parameter value for each transport link over which the multiple media flows are transported in the transport network. The processor 110 is further operable to compare the respective performance parameter value to a performance threshold and detect, based on the comparison, a router of the routers present in the transport network and configured to route the multiple media flows, wherein this router is in the congestion state. The processor 110 is, in this embodiment, additionally operable to identify the media flow based on the information of the detected router, the mapping information and at least a portion of the flow identifiers.

In another embodiment, the processor 110 is operable to perform two-way network performance measurements between the sender and the receiver and for each media flow of the multiple media flows having a respective DSCP value. The processor 110 is preferably also operable to calculate, based on the two-way network performance measurements, a respective performance parameter value for each media flow of the multiple media flows. In this embodiment, the processor 110 is further operable to compare the respective performance parameter values to a performance threshold and detect, based on the comparison, a flow route that is in the congestion state. The processor 110 is additionally operable to identify the media flow based on information of the detected flow route, at least a portion of the flow identifiers and the mapping information.

In a particular implementation embodiment, the processor 110 is operable to transmit, for each media flow of the multiple media flows and to the receiver, TWAMP test packets having a same source address, a same destination address and a same DSCP value as the media flow. The processor 110 is also operable to receive, from the receiver, TWAMP test packets time stamped by the receiver.

In another particular embodiment, the processor 110 is operable to perform two-way network performance measurements between the sender and each router of the routers present in the transport network and configured to route media flows through the detected flow route. The processor 110 is also operable to calculate, based on the two-way network performance measurements, a respective performance parameter value for each transport link for the detected flow route in the transport network. The processor 110 is preferably also operable to compare the respective performance parameter values to a performance threshold and detect, based on this comparison, a router that is in the congestion state of the routers present in the transport network and configured to route media flows through the detected flow route. In this embodiment, the processor 110 is additionally operable to identify the media flow, a media rate of which to adapt, based on information of the detected router, at least a portion of the flow identifiers and the mapping information.

In an embodiment, the device for congestion control 200 is implemented as comprising a CCM 210 and a BDM 220 as illustrated in FIG. 18. The CCM 210 and the BDM 220 are operable to communicate with each other preferably using the previously mentioned API.

In an embodiment, the CCM 210 preferably comprises an input/output (I/O) interface 212 operable to communicate with the BDM as shown in FIG. 19. The CCM 210 preferably also comprises a processor 214 and a memory 216. The BDM 220 correspondingly preferably comprises an I/O interface 222 operable to communicate with the CCM, a processor 224 and a memory 226 as shown in FIG. 20.

The processors 214, 224 of the CCM 210 and the BDM 220 then basically correspond to and performs the operations of the processor 110 as shown in FIG. 17. Correspondingly, the memories 216, 226 of the CCM 210 and the BDM 220 together correspond to the memory 120 in FIG. 17. The CCM 210 and the BDM 220 may each have an own I/O interface 212, 222, processor 214, 224 and/or memory 216, 226. Alternatively and in particular when the CCM 210 and the BDM 220 are implemented together in a device for congestion control 200 in a sender, a common I/O interface, processor and/or memory could be shared between the CCM 210 and the BDM 220.

The processor 214 of the CCM 210 is preferably operable to assign the respective flow identifier to each media flow of the multiple media flows. The processor 214 is also operable to control adaptation of a media rate of a media flow of the multiple media flows that is identified based on at least a portion of the flow identifiers and the mapping information.

The processor 224 of the BDM 220 is preferably operable to perform the two-way network performance measurements between the sender and at least one of the receiver and the routers. The processor 224 is also operable to detect the congestion state in the transport network based on at least a portion of the two-way network performance measurements.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

FIG. 21 is an illustration of an embodiment of a device for congestion control 300 that is may implemented in hardware as mentioned above. The device 300 comprises an identifier assigning unit 310 operable to assign the respective flow identifier to each media flow of the multiple media flows. A measurement unit 320 of the device 300 is operable to perform the two-way network performance measurements between the sender and at least one of the receiver and the routers. The device 300 also comprises a detecting unit 330 operable to detect the congestion state in the transport network based on at least a portion of the two-way network performance measurements. An identifying unit 340 is operable to identify the media flow of the multiple media flows based on at least a portion of the flow identifiers and the mapping information.

The measurement unit 320 is preferably connected to the identifier assigning unit 310 in order to access the flow identifiers assigned to the media flows and in particular, in an embodiment, DSCP values from the flow identifiers. In such a case, the DSCP values of the media flows can be re-used in the two-way network performance measurements, preferably TWAMP measurements, as previously discussed herein. The results of the two-way network performance measurements are preferably forwarded from the measurement unit 320 to the detecting unit 330 to be used therein to detect any congestion state. If such a congestion state is detected, the detecting unit 330 informs the identifying unit 340 to identify one or more media flows, the media rate of which to be adapted in order to combat the congestion state.

Alternatively, at least some of the steps, functions, procedures, modules and/or blocks described herein may be implemented in software such as a computer program for execution by suitable processing circuitry such as one or more processors or processing units.

The flow diagram or diagrams presented herein may therefore be regarded as a computer flow diagram or diagrams, when performed by one or more processors. A corresponding device may be defined as a group of function modules, where each step performed by the processor corresponds to a function module. In this case, the function modules are implemented as a computer program running on the processor.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

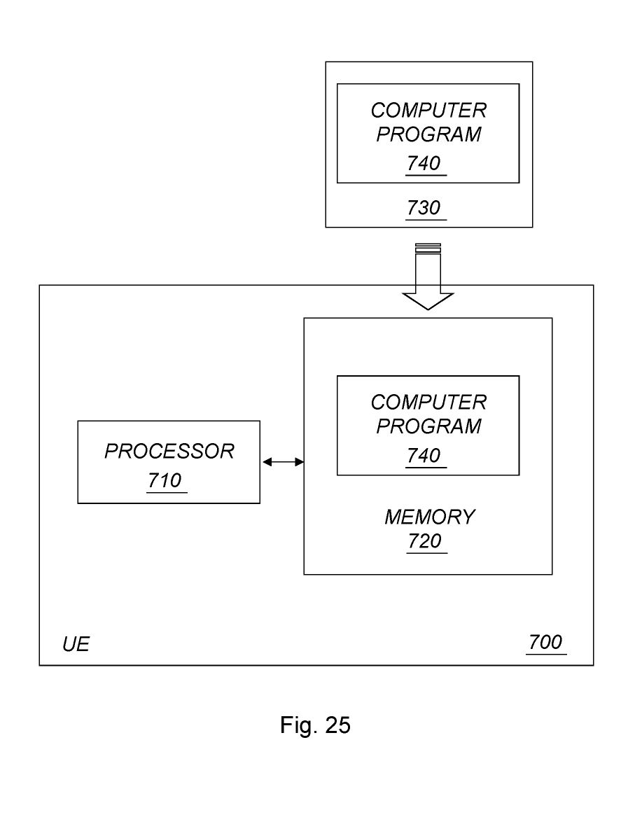

In the following, an example of a computer implementation will be described with reference to FIG. 25. A user equipment (UE) 700 comprises processing circuitry such as one or more processors 710 and a memory 720. In this particular example, at least some of the steps, functions, procedures, modules and/or blocks described herein are implemented in a computer program 740, which is loaded into the memory 720 for execution by the processor 710. The processor 710 and memory 720 are interconnected to each other to enable normal software execution.

The term ‘user equipment’ should be interpreted in a general sense as any system, apparatus or device capable of executing program code or computer program instructions to perform a particular processing, determining or computing task.

In a particular embodiment, the computer program 740 comprises program code or code means which when executed by the processor 710 causes the processor 710 to assign a respective flow identifier to each media flow of multiple media flows having a same source address and a same destination address. The program code also causes the processor 710 to perform two-way network performance measurements between a sender of the multiple media flows and at least one of a receiver of the multiple media flows and routers present in a transport network and configured to route the multiple media flows from the sender through the transport network to the receiver. The program code further causes the processor 710 to detect a congestion state in the transport network affecting at least one media flow of the multiple media flows in the transport network based on at least a portion of the two-way network performance measurements. The program code additionally causes the processor to identify a media flow of the multiple media flows, a media rate of which is to be adapted to combat the congestion state, based on at least a portion of the flow identifiers and mapping information defining a mapping between flow routes through the transport networks and flow identifiers for the multiple media flows.

The software or computer program 740 may be realized as a computer program product 730, which is normally carried or stored on a computer-readable medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Universal Serial Bus (USB) memory, a Hard Disk Drive (HDD) storage device, a flash memory, or any other conventional memory device. The computer program 740 may thus be loaded into the operating memory of a computer or equivalent user equipment for execution by the processor 710 thereof.

Hence, an aspect of the embodiments relates to a computer program product 730 comprising computer readable code mans and a computer program 740 as defined above stored on the computer readable code means.

As indicated herein, the device for congestion control may alternatively be defined as a group of function modules, where the function modules are implemented as a computer program running on a processor.

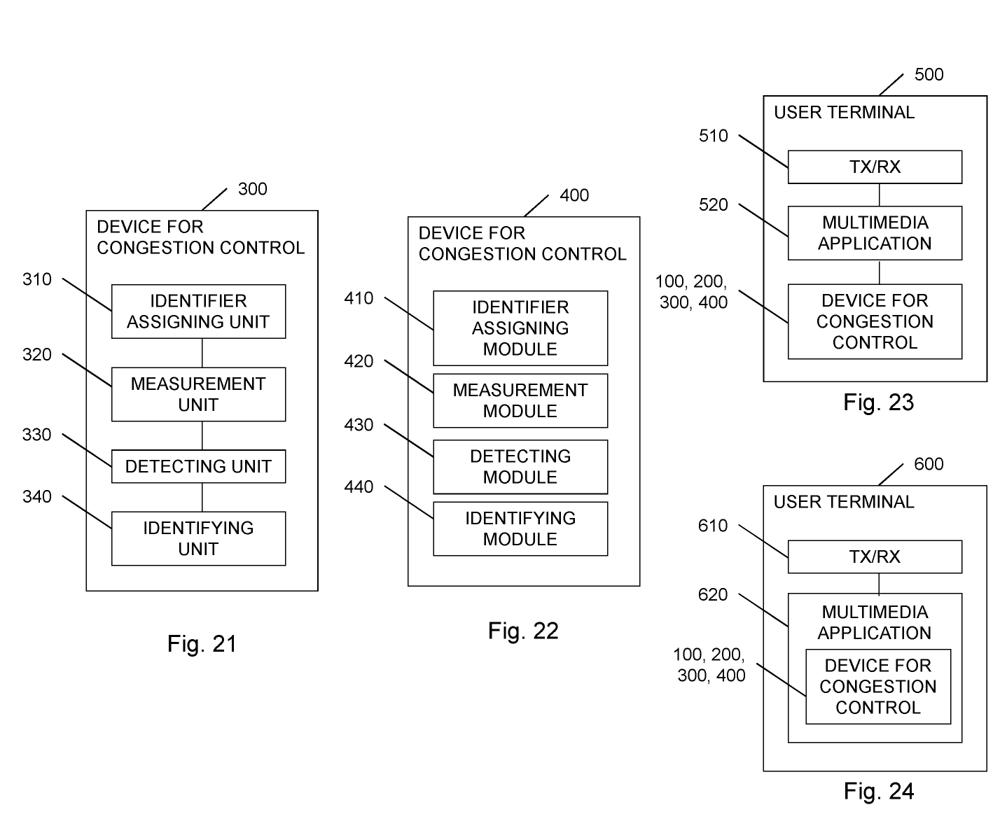

The computer program residing in memory may thus be organized as appropriate function modules configured to perform, when executed by the processor, at least part of the steps and/or tasks described herein. An example of such function modules is illustrated in FIG. 22. This FIG. 22 is a schematic block diagram illustrating an example of a device for congestion control comprising a group of function modules 410-440. In particular, the device 400 comprises an identifier assigning module 410 for assigning a respective flow identifier to each media flow of multiple media flows having a same source address and a same destination address. The device 400 also comprises a measuring module 420 for performing two-way network performance measurements between a sender of the multiple media flows and at least one of a receiver of the multiple media flows and routers present in a transport network and configured to route the multiple media flows from the sender through the transport network to the receiver. The device 400 further comprises a detecting module 430 for detecting a congestion state in the transport network affecting at least one media flow of the multiple media flows in the transport network based on at least a portion of the two-way network performance measurements. The device 400 additionally comprises an identifying module 440 for identifying a media flow of the multiple media flows, a media rate of which is to be adapted to combat the congestion state, based on at least a portion of the flow identifiers and mapping information defining a mapping between flow routes through the transport networks and flow identifiers for the multiple media flows.

FIGS. 23 and 24 illustrate examples or a user terminal 500, 600 comprising a device for congestion control 100, 200, 300, 400 according to the embodiments.

The user terminal 500, 600 preferably also comprises a transmitter (TX) and a receiver (RX), exemplifies as a common transceiver 510, 610 in the figures. The transceiver 510, 610 is then employed for transmitting data packets of media data of the multiple media flows from the user terminal 500, 600 through routers in the transport network towards the receiver. The transceiver 510, 610 is preferably also operable to conduct the two-way network performance measurements, such as transmitting and receiving TWAMP test packets.

The figures also illustrate the multimedia application 520, 620 that generates or at least provides the media flows to be transmitted by the transceiver 510, 620. In FIG. 23 the device for congestion control 100, 200, 300, 400 is arranged separate from but preferably connected to the multimedia application 520. However, in FIG. 23 the device for congestion control 100, 200, 300, 400 is implemented as a part of the multimedia application 620.

The user terminal 500, 600, 700 of FIGS. 23-25 can be any device, apparatus or unit that is able to transmit media flows through a transport network towards a receiver. Non-limiting examples include mobile devices, such as mobile telephones, tablets, video cameras; computers, media engines, media servers, media aware network elements, etc.

The embodiments described above are to be understood as a few illustrative examples of the present technology. It will be understood by those skilled in the art that various modifications, combinations and changes may be made to the embodiments without departing from the scope of the present technology. In particular, different part solutions in the different embodiments can be combined in other configurations, where technically possible. The scope of the present technology is, however, defined by the appended claims.

1. A method of congestion control for a multimedia session, said method comprising:
assigning a respective flow identifier to each media flow of multiple media flows having a same source address and a same destination address;
performing two-way network performance measurements between a sender of said multiple media flows and at least one of a receiver of said multiple media flows and routers present in a transport network and configured to route said multiple media flows from said sender through said transport network to said receiver;
detecting, based on at least a portion of said two-way network performance measurements, a congestion state for a flow route in said transport network affecting at least one media flow of said multiple media flows in said transport network; and
identifying a media flow of said multiple media flows, a media rate of which is to be adapted to combat said congestion state for said flow route, based on at least a portion of said flow identifiers and mapping information defining a mapping between flow routes through said transport network and flow identifiers for said multiple media flows.

2. The method according to claim 1, wherein performing said two-way network performance measurements comprises performing Two Way Active Measurement Protocol, TWAMP, measurements between said sender and at least one of said receiver and said routers.

3. The method according to claim 1, wherein assigning said respective flow identifier comprises:
registering said multiple media flows originating from an application in said sender at a congestion control module, CCM; and
said CCM assigning a respective flow identifier to each media flow registered at said CCM.

4. The method according to claim 3, further comprising said CCM registering said flow identifiers at a bottleneck detection module, BDM, using an application programming interface, API, wherein:
performing said two-way network performance measurements comprises said BDM performing said two-way network performance measurements between said sender and at least one of said receiver and said routers; and
detecting said congestion state comprises said BDM detecting said congestion state for said flow route in said transport network based on at least a portion of said two-way network performance measurements.

5. The method according to claim 4, further comprising:
said BDM communicating, to said CCM, a respective flow identifier of any media flow affected by said congestion state for said flow route, said respective flow identifier is provided by said BDM based on said mapping information; and
said CCM controlling adaptation of a media rate of said media flow identified based said respective flow identifiers.

6. The method according to claim 1, wherein a first media flow of said multiple media flows is routed through a first flow route in said transport network between said sender and said receiver and a second media flow of said multiple media flows is routed through a second, different flow route in said transport network between said sender and said receiver.

7. The method according to claim 1, wherein:
performing said two-way network performance measurements comprises a bottleneck detection module, BDM, performing two-way network performance measurements between said sender and each router of said routers present in said transport network and configured to route said multiple media flows;
detecting said congestion state comprises:
said BDM calculating, based on said two-way network performance measurements, a respective performance parameter value for each transport link over which said multiple media flows are transported in said transport network;
said BDM comparing said respective performance parameter values to a performance threshold; and
said BDM detecting, based on said comparison, a router that is in said congestion state of said routers present in said transport network and configured to route said multiple media flows; and
identifying said media flow comprises identifying said media flow based on information of said detected router, said at least a portion of said flow identifiers and said mapping information.

8. The method according to claim 7, wherein identifying said media flow comprises:
said BDM providing, based on said mapping information, respective flow identifier of any media flow routed through said detected router;
said BDM communicating said respective flow identifier to a congestion control module, CCM, using an application programming interface, API; and
said CCM controlling adaptation of a media rate of said media flow identified based said respective flow identifiers.

9. The method according to claim 1, wherein:
performing said two-way network performance measurements comprises a bottleneck detection module, BDM, performing two-way network performance measurements between said sender and said receiver for each media flow of said multiple media flows having a respective differentiated services code point, DSCP, value;
detecting said congestion state comprises:
said BDM calculating, based on said two-way network performance measurements, a respective performance parameter value for each media flow of said multiple media flows;
said BDM comparing said respective performance parameter values to a performance threshold; and
said BDM detecting, based on said comparison, a flow route that is in said congestion state; and
identifying said media flow comprises identifying said media flow based on information of said detected flow route, at least a portion of said flow identifiers and said mapping information.

10. The method according to claim 9, wherein identifying said media flow comprises:
said BDM communicating, to a congestion control module, CCM, a respective flow identifier of any media flow affected by said congestion state for said flow route, said respective flow identifier is provided by said BDM based on said mapping information; and
said CCM controlling adaptation of a media rate of said media flow identified based said respective flow identifier.

11. The method according to claim 9, wherein performing said two-way network performance measurements comprises:
said BDM transmitting, for each media flow of said multiple media flows, Two Way Active Measurement Protocol, TWAMP, test packets having a same source address, a same destination address and a same DSCP value as said media flow to a BDM of said receiver; and
said BDM receiving, from said BDM of said receiver, TWAMP test packets time stamped by said BDM of said receiver.

12. The method according to claim 9, further comprising:
said BDM performing two-way network performance measurements between said sender and each router of said routers present in said transport network and configured to route media flows through said detected flow route;
said BDM calculating, based on said two-way network performance measurements, a respective performance parameter value for each transport link for said detected flow route in said transport network;
said BDM comparing said respective performance parameter values to a performance threshold; and
said BDM detecting, based on said comparison, a router that is in said congestion state of said routers present in said transport network and configured to route media flows through said detected flow route,
wherein identifying said media flow comprises identifying said media flow based on information of said detected router, at least a portion of said flow identifiers and said mapping information.

13. A device for congestion control of a multimedia session, said device is configured to:
assign a respective flow identifier to each media flow of multiple media flows having a same source address and a same destination address;
perform two-way network performance measurements between a sender of said multiple media flows and at least one of a receiver of said multiple media flows and routers present in a transport network and configured to route said multiple media flows from said sender through said transport network to said receiver;
detect a congestion state in said transport network affecting at least one media flow of said multiple media flows in said transport network based on at least a portion of said two-way network performance measurements; and
identify a media flow of said multiple media flows, a media rate of which is to be adapted to combat said congestion state, based on at least a portion of said flow identifiers and mapping information defining a mapping between flow routes through said transport network and flow identifiers for said multiple media flows.

14. The device according to claim 13, further comprising:
a processor; and
a memory, wherein said processor is configured to execute instructions stored in the memory to:
assign said respective flow identifier to each media flow of multiple media flows;
perform said two-way network performance measurements between said sender and at least one of said receiver and said routers;
detect said congestion state in said transport network based on at least a portion of said two-way network performance measurements; and
identify said media flow of said multiple media flows based on at least a portion of said flow identifiers and said mapping information.

15. The device according to claim 14, wherein said processor is configured to perform Two Way Active Measurement Protocol, TWAMP, measurements between said sender and at least one of said receiver and said routers.

16. The device according to claim 14 or 15, wherein said processor is configured to:
register said multiple media flows originating from an application (520, 620) in said sender; and
assign a respective flow identifier to each registered media flow.

17. The device according to claim 14, wherein said processor is configured to:
perform two-way network performance measurements between said sender and each router of said routers present in said transport network and configured to route said multiple media flows;
calculate, based on said two-way network performance measurements, a respective performance parameter value for each transport link over which said multiple media flows are transported in said transport network;
compare said respective performance parameter values to a performance threshold;
detect, based on said comparison, a router of said routers present in said transport network and configured to route said multiple media flows that is in said congestion state; and
identify said media flow based on information of said detected router, said at least a portion of said flow identifiers and said mapping information.

18. The device according to claim 14, wherein said processor is configured to:
perform two-way network performance measurements between said sender and said receiver for each media flow of said multiple media flows having a respective differentiated services code point, DSCP, value;
calculate, based on said two-way network performance measurements, a respective performance parameter value for each media flow of said multiple media flows;
compare said respective performance parameter values to a performance threshold;
detect, based on said comparison, a flow route that is in said congestion state; and
identify said media flow based on information of said detected flow route, at least a portion of said flow identifiers and said mapping information.

19. The device according to claim 18, wherein said processor is configured to:
transmit, for each media flow of said multiple media flows, Two Way Active Measurement Protocol, TWAMP, test packets having a same source address, a same destination address and a same DSCP value as said media flow to said receiver; and
receive, from said receiver, TWAMP test packets time stamped by said receiver.

20. The device according to claim 18, wherein said processor is configured to:
perform two-way network performance measurements between said sender and each router of said routers present in said transport network and configured to route media flows through said detected flow route;
calculate, based on said two-way network performance measurements, a respective performance parameter value for each transport link for said detected flow route in said transport network;
compare said respective performance parameter values to a performance threshold;
detect, based on said comparison, a router that is in said congestion state of said routers present in said transport network and configured to route media flows (40 through said detected flow route); and
identify said media flow based on information of said detected router, at least a portion of said flow identifiers and said mapping information.

21. The device according to claim 13, further comprising:
a congestion control module, CCM, comprising:
an input/output interface operable to communicate with a bottleneck detection module, BDM;
a processor; and
a memory; and
a BDM comprising:
an input/output interface operable to communicate with said CCM;
a processor; and
a memory, wherein
wherein said processor of said CCM is configured to execute instructions stored in the memory of said CCM to:
assign said respective flow identifier to each media flow of multiple media flows; and
control adaption of a media rate of media flow of said multiple media flows identified based on at least a portion of said flow identifiers and said mapping information; and
said processor of said BDM is configured to execute instructions stored in the memory of said BDM to:
perform said two-way network performance measurements between said sender and at least one of said receiver and said routers; and
detect said congestion state in said transport network based on at least a portion of said two-way network performance measurements.

22. The device according to claim 13, further comprising:
an identifier assigning unit configured to execute instructions stored in the memory of said BDM to:
to assign said respective flow identifier to each media flow of multiple media flows;
a measurement unit configured to perform said two-way network performance measurements between said sender and at least one of said receiver and said routers;
a detecting unit configured to detect said congestion state in said transport network based on at least a portion of said two-way network performance measurements; and
an identifying unit configured to identify said media flow of said multiple media flows based on at least a portion of said flow identifiers and said mapping information.

23. A device for congestion control of a multimedia session, said device comprising:
an identifier assigning module for assigning a respective flow identifier to each media flow of multiple media flows having a same source address and a same destination address;
a measuring module for performing two-way network performance measurements between a sender of said multiple media flows and at least one of a receiver of said multiple media flows and routers present in a transport network and configured to route said multiple media flows from said sender through said transport network to said receiver;
a detecting module for detecting a congestion state in said transport network affecting at least one media flow of said multiple media flows in said transport network based on at least a portion of said two-way network performance measurements; and
an identifying module for identifying a media flow of said multiple media flows, a media rate of which is to be adapted to combat said congestion state, based on at least a portion of said flow identifiers and mapping information defining a mapping between flow routes through said transport network and flow identifiers for said multiple media flows.

24. A user terminal comprising a device for congestion control according to claim 13.

25. A computer program product comprising a non-transitory computer readable storage medium storing program code which when executed by a processor causes said processor to:
assign a respective flow identifier to each media flow of multiple media flows having a same source address and a same destination address;
perform two-way network performance measurements between a sender of said multiple media flows and at least one of a receiver of said multiple media flows and routers (10,1 2) present in a transport network and configured to route said multiple media flows (40, 4 2) from said sender through said transport network to said receiver;
detect a congestion state in said transport network affecting at least one media flow of said multiple media flows in said transport network based on at least a portion of said two-way network performance measurements; and
identify a media flow of said multiple media flows, a media rate of which is to be adapted to combat said congestion state, based on at least a portion said flow identifiers and mapping information defining a mapping between flow routes through said transport network and flow identifiers for said multiple media flows.

26. (canceled)
